(19) United States
(12) Patent Application Publication
(10) Pub. No.: US 2002/0114099 A1
(43) Pub. Date: Aug. 22, 2002

(54) Magnetic disc apparatus

(76) Inventor: Akihito Nakayama, Tokyo (JP)

Correspondence Address: COOPER & DUNHAM LLP, 1185 Avenue of the Americas, New York, NY, 10036, US

(21) Appl. No.: 09/974,316

(22) Filed: Oct. 9, 2001

(30) Foreign Application Priority Data
Oct. 11, 2000 (JP) P2000-311322

(51) Int. Cl. G11B 5/596

(52) U.S. Cl. 360/77.03

(57) ABSTRACT

A magnetic disc apparatus comprises a magnetic disc and a magnetic head for recording and/or playing back an information signal on the magnetic disc. A control signal is generated on the basis of a servo signal recorded on the magnetic disc. The position of the support arm is detected by a hologram grating provided on the support arm and by a hologram sensor unit mounted on a base, whereby a position signal is generated. The control signal is corrected on the basis of the position signal. The actuation of the support arm is controlled based on the corrected control signal, such that the magnetic head can be positioned with respect to the magnetic disc with high accuracy.

### BACKGROUND OF THE INVENTION

1. Field of the Invention

The present invention relates to a magnetic disc apparatus for recording and/or playing back an information signal on a magnetic disc.

2. Description of the Related Art

The magnetic disc apparatus is known as an apparatus for the recording and/or playback (hereafter referred to as “recording/playback”) of an information signal. In the magnetic disc apparatus, a magnetic signal is recorded and/or played back on or from a signal recording surface of a rotating magnetic disc by a magnetic head, thereby recording and/or playing back the information signal.

Such magnetic disc apparatus has been widely used as an external recording apparatus for computer systems. Nowadays, it is widely expected that the magnetic disc apparatus will be mounted on hard disc recording equipment, replacing the VCR as a device for a long-hour recording of video and audio signals, or be mounted on home server equipment for a central management of various household information. Accordingly, there is a growing demand for increasing the storage capacity and therefore the recording density of the magnetic disc apparatus.

In order to achieve a high recording density in the magnetic disc apparatus, it is necessary to reduce the pitch of the recording tracks along the radius of the magnetic disc, as well as increase the linear recording density along the scan direction of the magnetic disc. The reduction in track pitch requires an improvement in the accuracy with which the magnetic head is positioned.

Generally, the positioning accuracy of the magnetic head in the magnetic disc apparatus must be on the order of 10%-15% of the track pitch. For example, when the track pitch is as small as 1 μm, it is necessary to position the magnetic head on the signal recording surface of the magnetic disc with an accuracy on the order of 100 nm to 150 nm.

For achieving such a highly accurate positioning of the magnetic head, it is important to reduce steady-state deviations and make system more resistant to disturbance. For these purposes, it is necessary to raise the servo band of the support arm which supports the magnetic head and transports it along the radius of the magnetic disc.

However, the servo band in a control system is limited by mechanical resonances occurring in the controlled object. The mechanical resonances are caused by, for example, the spindle motor by which the magnetic disc is rotated, the rotation of the magnetic disc, the chassis of the magnetic disc apparatus, and the rotation axle of the support arm.

According to the prior art, the magnetic disc apparatus controls the positioning of the magnetic head by such a control system as shown in FIG. 21. In this example, a signal indicating a predetermined tracking position for recording/playback is input to the control system on the basis of a position error signal recorded in the magnetic disc. The signal indicating the track position is then digitally processed by a phase lead-lag filter 200 and a loop gain unit 201, thereby producing a control signal. Based on the control signal, the voice coil motor (VCM) of a support arm 202 is actuated, such that the magnetic head, which is attached to the tip of the support arm 202 via a suspension 203, is transported to a predetermined position. Thereafter the information signal is recorded on or played back from the magnetic disc. At the same time, the position error signal recorded in the magnetic disc is read. The position error signal is fed back to the phase lead-lag filter 200.

The control effected to the support arm 202 is influenced by an inherent coupling coefficient 204, and a mechanical resonance (pivot resonance) 205 occurring in the rotation axle of the support arm 202. The control performed on the support arm 202 is also influenced by resonances such as a chassis resonance 206 occurring in the base of the magnetic disc apparatus, an SPM resonance 207 occurring in the spindle motor itself, and a disc resonance 208 occurring in the magnetic disc. These resonances are due to such a source of vibration as the spindle motor (SPM) for rotating the magnetic disc.

Thus, in the conventional magnetic disc apparatus, the support arm 202 is controlled by the control signal such that the magnetic head is correctly positioned on the signal recording surface of the magnetic disc. Such control is influenced by various factors, including the eccentricity with which the position error signal is formed in the magnetic disc with respect to the rotation axle, as well as the various kinds of mechanical resonance as mentioned above. Accordingly, it has been difficult to highly accurately position the magnetic head in the prior art.

In the conventional magnetic disc apparatus where the 3.5-inch magnetic disc is used, large mechanical resonances exist in the frequency band ranging from 3 kHz to 10 kHz. This limits the servo band to the frequency band ranging from several hundred hertz to about 1 kHz. Likewise, in the magnetic disc apparatus using the 2.5-inch magnetic disc, the servo band can be set no higher than 2 kHz. Thus, it has been difficult to set the servo band higher to achieve a highly accurate positioning of the magnetic head, which in turn makes it difficult to achieve a high recording density and storage capacity.

For the highly accurate positioning of the magnetic head, it is also important to actuate the support arm with high precision. However, in a region where the support arm is actuated very finely, influences of nonlinear components such as the bearing become significant, adversely affecting the control performance.

### SUMMARY OF THE INVENTION

Accordingly, it is an object of the present invention to provide a magnetic disc apparatus by which the magnetic head can be highly accurately positioned with respect to the magnetic disc and thus a high recording density can be achieved.

A magnetic disc apparatus according to the present invention comprises a magnetic disc, a spindle motor, a magnetic head, a support mechanism, position detection means, and control means. The magnetic disc records an information signal and a position error signal. The spindle motor rotates the magnetic disc. The magnetic head records and/or plays back the information signal on the magnetic disc. The support mechanism supports the magnetic head such that the magnetic head can be transported along the radius of the magnetic disc. The position detection means detects the position of the magnetic head and outputs a position signal. The control means produces a control signal based on the position error signal detected by the magnetic head. The control means also corrects the control signal on the basis of the position signal output by the position detection means. Based on the corrected control signal, the control means controls the actuation of the support mechanism such that the magnetic head can be transported to a predetermined position for the recording/playback of the information signal.

Thus, in the magnetic disc apparatus according to the present invention, the control signal is produced on the basis of the position error signal recorded on the magnetic disc. The control signal is then corrected by the position signal output from the position detection means. The positioning of the magnetic head is therefore controlled by the corrected control signal. As opposed to the position error signal recorded in the magnetic disc, the position signal output from the position detection means indicates the position of the magnetic head as detected externally. Thus, the position signal is not dependent on the rotation of the magnetic disc and therefore has reduced the influences of the resonance frequencies of the mechanical resonances due to the rotation of the magnetic disc. At the same time, the servo sampling frequency can be greatly increased. Accordingly, the influences of sampling time delay, for example, can be reduced and, as a result, the servo band can be set higher.

In the magnetic disc apparatus according to the present invention, the position detection means may detect the position of the support mechanism supporting the magnetic head. Since the magnetic head is fixedly supported by the support mechanism, the position of the magnetic head can be determined by detecting the position of the support mechanism. In this case, too, the servo sampling frequency can be greatly increased because the resonance frequencies of the mechanical resonances in the support mechanism are higher than those of the mechanical resonances in other parts.

In the magnetic disc apparatus according to the present invention, the magnetic disc preferably records the position error signal by recording a magnetic signal on minute concave/convex patterns formed on the signal recording surface of the magnetic disc where the information signal is recorded. In this manner, the position error signal can be highly accurately recorded on the magnetic disc, which helps the control means to control the support mechanism even more accurately.

In the magnetic disc apparatus according to the present invention, the position detection means preferably has a resolution of 1/40 or smaller with respect to the track pitch of the recording tracks formed on the magnetic disc. Such a high resolution of the position detection means, when combined with the high setting of the servo band, provides the magnetic disc apparatus with synergetic effects. For example, the influence of the nonlinear components of the bearing and the like, which becomes significant during the fine actuation of the support mechanism, can be sufficiently absorbed, thereby making it possible to control the support mechanism highly accurately.

In the magnetic disc apparatus according to the present invention, the position detection means preferably comprises an optical scale whereby a hologram is illuminated to thereby detect the position of the magnetic head. In this manner, a position detection means with a high resolution can be easily realized.

The magnetic disc apparatus according to the present invention preferably comprises filter means for band-limiting the position error signal detected by the magnetic head, so that only a predetermined frequency component is passed and output to the control means. In the present invention, since the control signal is corrected by the position signal output by the position detection means, the control loop concerning the position error signal detected by the magnetic head can be band-limited with an arbitrary frequency band. Accordingly, the frequency components related to the mechanical resonances occurring in various parts can be easily and effectively removed out of the position error signal by means of a high-order low-pass filter. Thus, the influence of mechanical resonance can be minimized, so that the positioning of the magnetic head can be highly accurately controlled.

### BRIEF DESCRIPTION OF THE DRAWINGS

The present invention will be hereafter described by way of preferred embodiments with reference made to the attached drawings in which:

FIG. 1 is a schematic plan view of a main portion of a magnetic disc apparatus according to the present invention;

FIG. 2 is a schematic side view of the main portion of the magnetic disc apparatus;

FIG. 3 is a schematic plan view of a support arm of the magnetic disc apparatus;

FIG. 4 is a schematic illustration of a hologram sensor unit 20 of the magnetic disc apparatus;

FIG. 5 is a schematic plan view showing a servo signal recorded on a magnetic disc of the magnetic disc apparatus;

FIG. 6A illustrates the concentric manner in which the servo signal is recorded on the magnetic disc in the magnetic disc apparatus, and FIG. 6B illustrates the spiral manner in which the servo signal is recorded on the magnetic disc;

FIG. 7 shows the format of the servo signal recorded on the magnetic disc;

FIG. 8 is a flowchart of an example of servo write operation for recording the servo signal on the magnetic disc in the magnetic disc apparatus;

FIG. 9 illustrates a step in the servo write operation for recording the servo signal on the magnetic disc in the magnetic disc apparatus;

FIG. 10 illustrates another step in the servo write operation for recording the servo signal on the magnetic disc in the magnetic disc apparatus;

FIG. 11 illustrates yet another step in the servo write operation for recording the servo signal on the magnetic disc in the magnetic disc apparatus;

FIG. 12 is a schematic plan view of the main portion of the magnetic disc apparatus for the explanation of the servo write operation;

FIG. 13 is a schematic side view of the main portion of the magnetic disc apparatus for the explanation of the servo write operation;

FIG. 14 is a schematic side view of the main portion of the magnetic disc apparatus for the explanation of a different example of the servo write operation;

FIG. 15 is a schematic plan view of the support arm for the explanation of the different example of the servo write operation;

FIG. 16 illustrates a step in the process of producing the magnetic disc by the stamping technology;

FIG. 17 illustrates another step in the process of producing the magnetic disc by the stamping technology;

FIG. 18 illustrates another step in the process of producing the magnetic disc by the stamping technology;

FIG. 19 shows an exemplary block diagram of a control circuit of the magnetic disc apparatus;

FIG. 20 shows a control block diagram of a control block of the magnetic disc apparatus;

FIG. 21 shows a control block diagram of a control block of a magnetic disc apparatus according to the prior art;

FIG. 22 shows graphs for the explanation of vibrations generated in the magnetic disc in the magnetic disc apparatus, plotting the vibration spectrum and PES in the case where the magnetic disc was rotated at 7200 rpm, and;

FIG. 23 shows a graph indicating the relationship between the amplitude and frequency of the vibration generated in the magnetic disc and the rotation speed of the magnetic disc in the case where the magnetic disc was made from a resin material.

### DESCRIPTION OF THE PREFERRED EMBODIMENTS

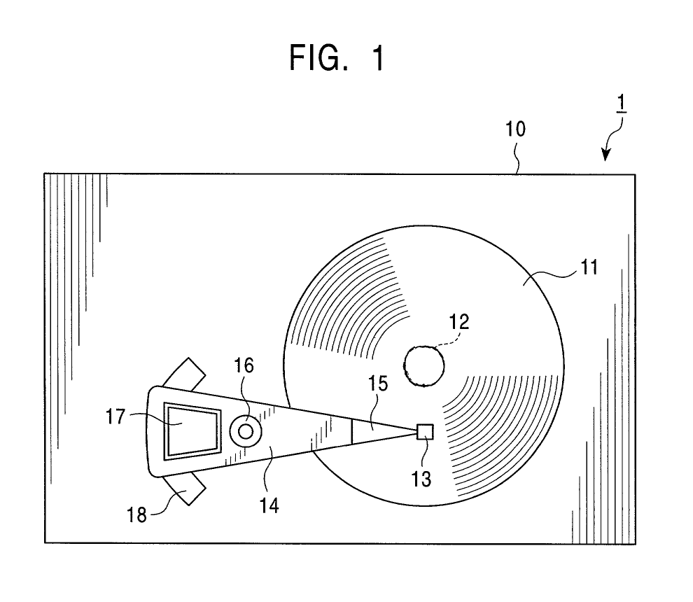

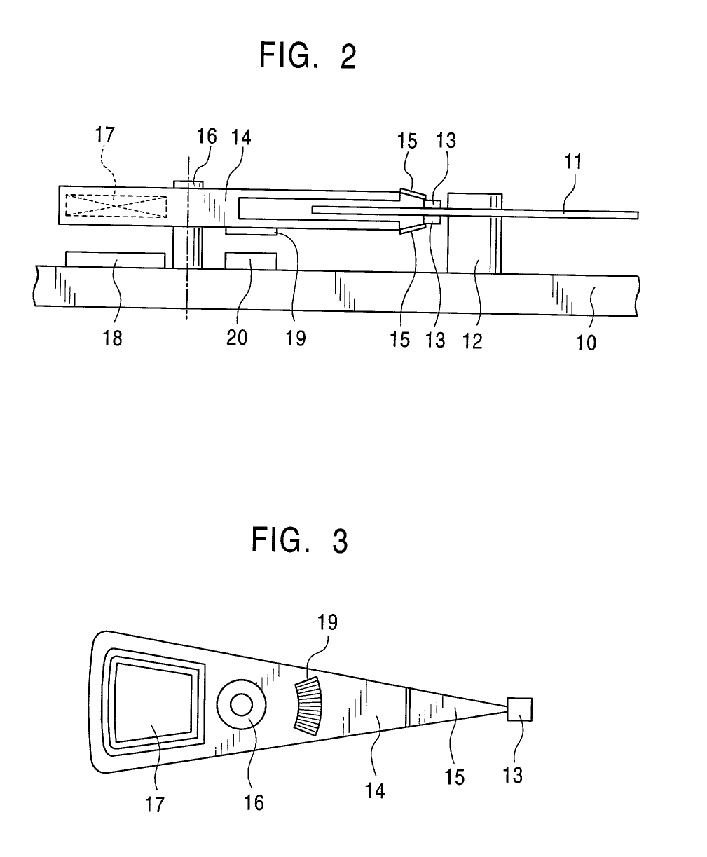

FIGS. 1 and 2 show a magnetic disc apparatus 1 as an embodiment of the present invention. The magnetic disc apparatus 1 comprises a base (chassis) 10, a magnetic disc 11 for recording an information signal, a spindle motor 12 for rotating the magnetic disc 11, magnetic heads 13 for recording/playback of the information signal on the magnetic disc 11, and a support arm 14 for supporting the magnetic heads 13 such that the magnetic heads 13 can be transported along the radius of the magnetic disc 11. The magnetic disc apparatus 1 further comprises a control circuit for controlling various parts of the system. The control circuit will be described later.

The magnetic disc 11 comprises a circular substrate formed from a glass, metal, or resin material with a diameter of 10 cm or more. On a main surface on each side of the substrate is formed a magnetic layer with a thickness ranging from 1 mm to 2.5 mm. A magnetic signal corresponding to the information signal is recorded and/or played back on or from the magnetic layer by the magnetic heads 13 at a linear recording density of 500 kbpi or more. The magnetic disc 11 also records a servo signal for use in transporting the magnetic heads 13 to a predetermined position. The servo signal will be described later.

As shown in FIG. 2, the magnetic heads 13 are mounted on the main surfaces on either side of the magnetic disc 11 and are each supported by the support arm 14 via a suspension 15 attached at the tip of the arm. Each magnetic head 13 is urged by the suspension 15 towards a signal recording surface of the magnetic disc 11. The urging force of the suspensions 15 are controlled to be balanced with the air flow caused when the magnetic disc 11 is rotating, such that the magnetic heads 13 during the rotation of the magnetic disc 13 are floated from the signal recording surfaces with a height on the order of several tens of nanometers. Thus, the magnetic disc apparatus 1 performs the recording/playback of the information signal on the magnetic disc 11 while the magnetic heads 13 are floated.

Each magnetic head 13 is in fact attached to a floating body called a floating slider for facilitating the floating movement of the heads. The floating slider is supported on the suspension 15 by a single point via a pivot, so that the magnetic heads 13 can be stably floated when they trace the signal recording surface of the magnetic disc 11.

The magnetic heads 13 may be of inductive type where a wire is wound on a magnetic core formed from a magnetic material. The magnetic heads 13 may also be of playback-only type comprising an AMR (anisotropic magneto-resistive) element, a GMR (giant magneto-resistive) element, or a TMR (tunneling magneto-resistive) element as a magneto-sensing element. Alternatively, the magnetic heads 13 may comprise a plurality of those magnetic heads. Further, the magnetic heads 13 may be constructed to record the magnetic signal in a direction perpendicular to either the magnetic layer of the magnetic disc 11 or the running direction along the tracks within the plane of the magnetic disc 11. Thus, the magnetic signal can be recorded with a higher density than in the case of the so-called longitudinal recording method, which is widely used in the prior art.

The support arm 14 is attached to the base 10 in such a manner as to be able to freely rotate about a rotation axle (pivot) 16. The support arm 14 has the magnetic heads 13 attached to one end thereof via the suspensions 15. Thus, the support arm 14 can rotate about the rotation axle 16 and thereby freely transport the magnetic heads along the radius of the magnetic disc 11, as well as supporting the magnetic heads 13.

On the other end of the support arm 14 is mounted a voice coil motor (VCM) 17. The magnetic disc apparatus 1 further comprises a magnet 18 fixedly mounted on the base 10 opposite the voice coil motor 17. Thus, the support arm 14 is designed to rotate about the rotation axle 16 by the action of an electromagnetic force which is generated between the voice coil motor 17 and magnet 18 when a predetermined current is supplied to the voice coil motor 17. Accordingly, in the magnetic disc apparatus 1, the support arm 14 is actuated by controlling the current supplied to the voice coil motor 17, whereby the magnetic heads 13 attached at the end the support arm 14 can be transported to a desired position on the magnetic disc 11.

The support arm 14 further comprises a hologram grating 19 mounted thereon, as shown in FIGS. 2 and 3. The hologram grating 19 comprises positional information recorded in the form of a grating along the direction of rotation of the support arm 14 with a predetermined pitch. As shown in FIG. 2, a hologram sensor unit 20 is mounted on the base 10 opposite the hologram grating 19. The hologram sensor unit 20 detects a reflected beam of light impinging on the hologram grating 19 to thereby detect the positional information recorded in the hologram grating 19. Thus, the magnetic disc apparatus 1 comprises an optical scale consisting of the hologram grating 19 mounted on the support arm 14 and the hologram sensor unit 20 mounted on the base 10, the scale functioning as position detection means for detecting the position of the support arm 14.

In the magnetic disc apparatus 1, since the magnetic heads 13 are fixedly supported at the tip of the support arm 14, the position of the magnetic heads 13 can be determined by detecting the position of the support arm 14 by means of the hologram grating 19 and hologram sensor unit 20.

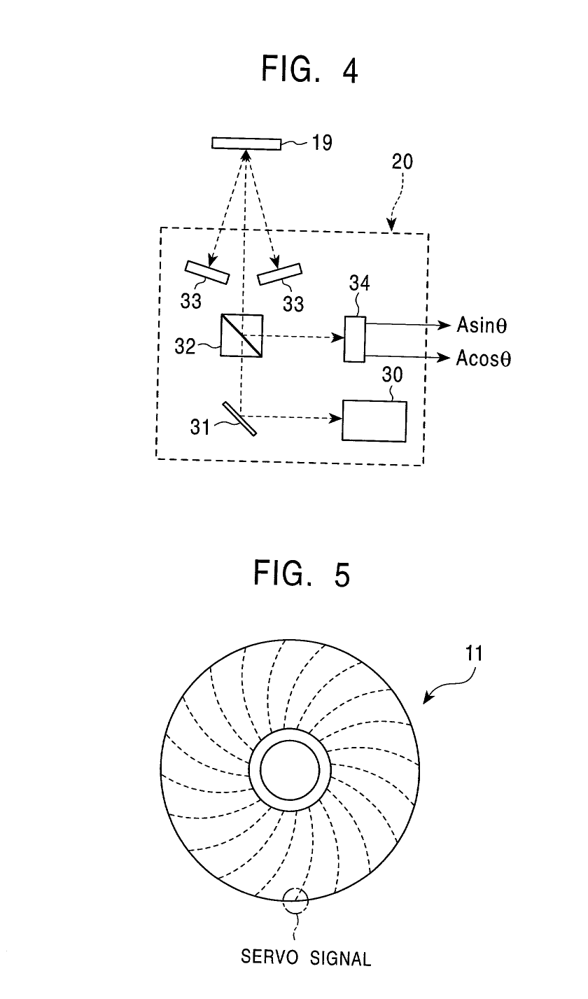

As shown in FIG. 4, the hologram sensor unit 20 comprises a laser light source 30 for emitting laser light with a predetermined wavelength, a mirror 31 for reflecting the laser light emitted by the laser light source 30, and a half-silvered mirror 32 on which the laser light reflected by the mirror 31 is incident. The laser light transmitted by the half-silvered mirror 32 and traveling in a straight line impinges on the hologram grating 19 mounted on the support arm 14 and thereby diffracted by the hologram grating 19. However, the hologram sensor unit 20 comprises a pair of reflecting mirrors 33 by which the diffracted light from the hologram grating 19 is reflected and made incident again on the half-silvered mirror 32. The laser light incident once again on the half-silvered mirror 32 is reflected thereby, and the reflected laser light is received by a photodetector 34 provided in the hologram sensor unit 20.

Based on the laser light received by the photodetector 34, the hologram sensor unit 20 detects the positional information recorded in the hologram grating 19, thereby determining the position of the support arm 14.

Specifically, the hologram grating 19 is moved relative to the hologram sensor unit 20 as the support arm 14 rotates. As a result, the photodetector 34 produces an output signal comprising a sine wave (Asinθ) and a cosine wave (Acosθ) with a period which is an integer multiple of the pitch of the positional information recorded in the hologram grating 19, where A is the amplitude of the output signal, and θ is the grating phase of the hologram grating 19. For example, when the pitch of θ is 1 μm, the optical scale consisting of the hologram grating 19 and hologram sensor unit 20 can be provided with a resolution of 1 nm by interpolating signals such that the single period is divided in 1000.

The magnetic disc apparatus 1 controls the actuation of the support arm 14 based on the position of the support arm 14 detected by the optical scale, as will be described in detail later.

Hereafter the servo signal recorded on the magnetic disc 11 equipped in the magnetic disc apparatus 1 will be described.

As shown in FIG. 5, the servo signals are recorded along individual concentric circles on each main surface in a dispersed manner. In the magnetic disc apparatus 1, the positioning of the magnetic heads 13 are performed based on the servo signals, as will be described later. Namely, the servo signal is used for transporting the magnetic heads 13 to a predetermined position.

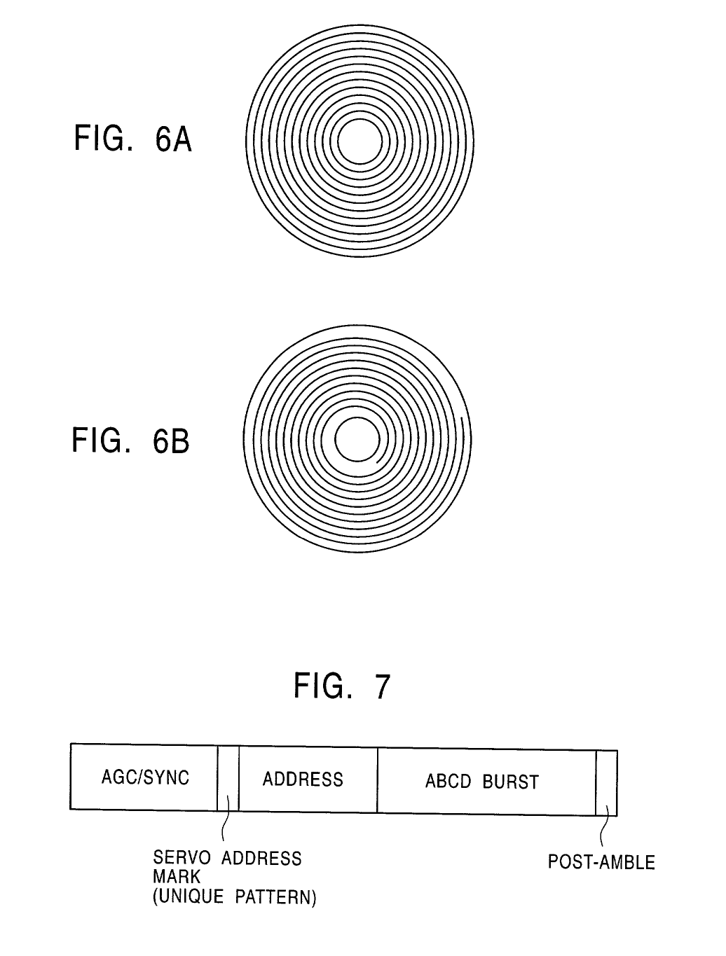

The servo signals may be recorded discretely at positions along the concentric circles on the main surface of the magnetic disc 11, as shown in FIG. 6A. Alternatively, they may be recorded discretely and spirally on the main surface of the magnetic disc 11, as shown in FIG. 6B. It should be noted that in FIGS. 6A and 6 B, the servo signals are simply described as recorded concentrically or spirally, and the discrete manner in which they are actually recorded is not illustrated for simplicity's sake.

Since the recording tracks are formed on the magnetic disc 11 at positions corresponding to the servo signals, the recording tracks are formed concentrically in the case of FIG. 6A and spirally in the case of FIG. 6B.

When the magnetic disc apparatus 1 is used for the recording/playback of large-sized and continuous data such as image data and audio data, it is preferable that the servo signals are recorded spirally as shown in FIG. 6B with the recording tracks formed spirally.

When the recording tracks are concentrically formed, data can be recorded and/or played back continuously only as long as the length of a single track of the magnetic disc 11 at maximum. This proves problematic when large-sized data must be recorded and/or played back, because such large-sized data must be recorded and/or played back in smaller portions, which necessitates a frequent jumping between the neighboring recording tracks during the recording/playback of the divided data. On the other hand, when the recording tracks are formed spirally, even large-sized data can be continuously recorded and/or played back in units of information longer than a single track of the magnetic disc 11. Thus, by adopting the spiral arrangement as shown in FIG. 6B, the fragmentation of the data can be prevented, the number of track jumps (accesses to the tracks) can be minimized, and a higher transfer rate can be achieved, thereby improving the recording/playback performance of the magnetic disc apparatus 1.

It should be noted, however, that even in the case of spirally forming the recording tracks, it is necessary to provide different track numbers to neighboring recording tracks. Accordingly, the track numbers must increase starting from a predetermined position on each main surface of the magnetic disc 11.

Each servo signal recorded on the main surface of the magnetic disc 11 has such a format as shown in FIG. 7 where various signals are arranged in order. Specifically, the format consists of an AGC/SYNC signal which is used for AGC (analog gain control) and for signal synchronization during a PLL (phase locked loop) operation, a servo address mark signal indicating the start of a servo signal, an address signal indicating a track address including the track number and sector number of the position where this servo signal was recorded, an ABCD burst signal for generating a position error signal (PES), and a post-amble indicating the end of the servo signal, arranged in this order.

The servo address mark signal is generally recorded as a pattern unique to each servo signal. The ABCD burst signal generally consists of four kinds of signals A, B, C, and D recorded over adjacent recording tracks. By detecting the individual signals constituting the ABCD burst signal and computing their peak levels during the recording/playback of the magnetic disc 11, the magnetic disc apparatus 1 can determine a positioning error (amount of displacement) of the magnetic heads 13 from a target recording track.

The magnetic disc 11 does not contain any information signal or servo signal immediately after being fitted on the magnetic disc apparatus 1. Accordingly, the servo signals described with reference to FIGS. 5 to 7 must be recorded prior to the recording/playback of the information signal through a process called “servo write”.

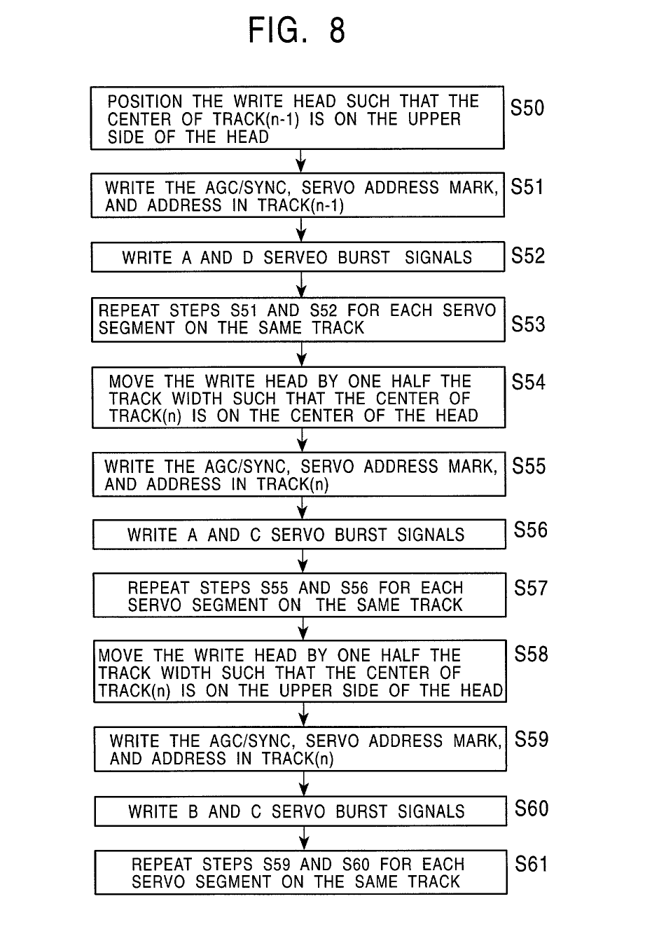

The recording/playback of the information signal on the magnetic disc 11 is possible only after the servo write operation is over, which will hereafter be described by referring to a flowchart of FIG. 8. The following description focuses on the ABCD burst signal among other signals constituting the servo signal. It is also assumed in the following description that the track width of a write head 70 for recording the servo signal is roughly the same as the width of the recording track.

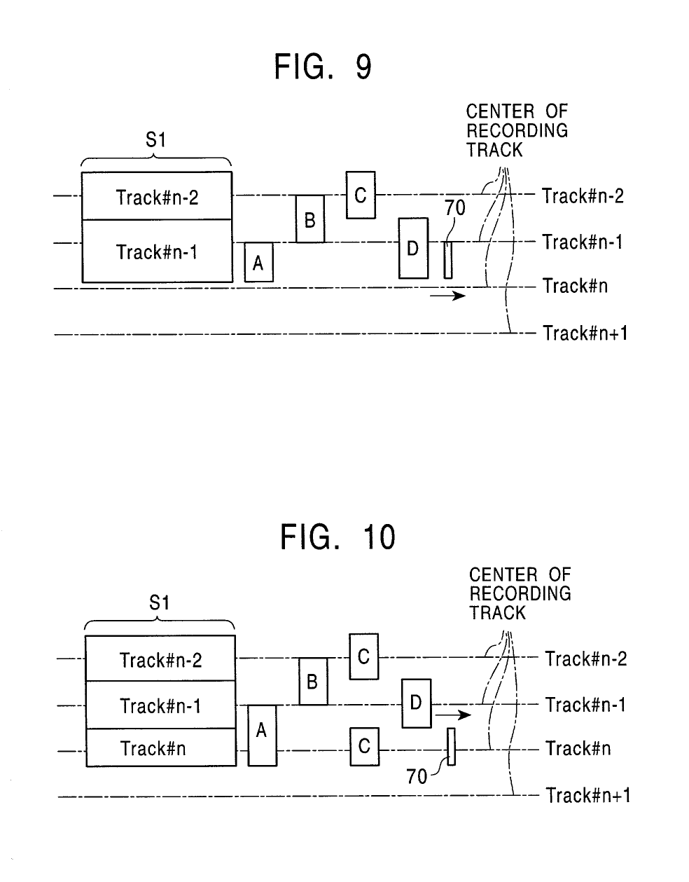

Referring to FIG. 8, the servo write operation is initiated in step S50. In this step, the write head 70 for recording the servo signal is positioned such that its one end (upper end in FIG. 9) is at the center (track center) of a recording track (n−1).

In step S51, the AGC/SYNC signal, the servo address mark signal, and the address signal in the servo signal are recorded by moving the write head 70 along the recording track (n−1) in a direction indicated by the arrow, as shown in FIG. 9. The region where those signals are recorded is indicated by S1 in FIG. 9.

Next, in step S52, the A and D signals among the signals constituting the ABCD burst signal in the servo signal are recorded. It should be noted that in FIG. 9, the B and C signals have already been recorded so that the servo signal for the recording track (n−2) has been completed. Further, in FIG. 9, part of the D signal has been previously recorded.

In step S53, steps S51 and S52 are performed for the other servo signal segments (servo segments) along the same concentric circle as that of the servo signal now being recorded. Thus, the same individual signals constituting the servo signal as recorded in steps S51 and S52 are also recorded in each of the other servo segments along the same concentric circle.

In step S54, the write head 70 is shifted by one half the track pitch of the recording track such that, as shown in FIG. 10, the center of the write head 70 coincides with the center of the recording track (n).

In step S55, the AGC/SYNC signal, the servo address mark signal, and the address signal among the signals constituting the servo signal are recorded by moving the write head 70 along the recording track (n) in a direction indicated by the arrow as shown in FIG. 10.

Next, in step S56, the A and C signals among the signals constituting the ABCD burst signal in the servo signal are recorded. Simultaneously, an end of the D signal which has been recorded in step S52 is erased, thereby recording the D signal at the center of the recording track (n−1) with the same width as that of the track.

In step S57, steps S55 and S56 are performed for the other servo segments located along the same concentric circle as that of the servo signal now being recorded.

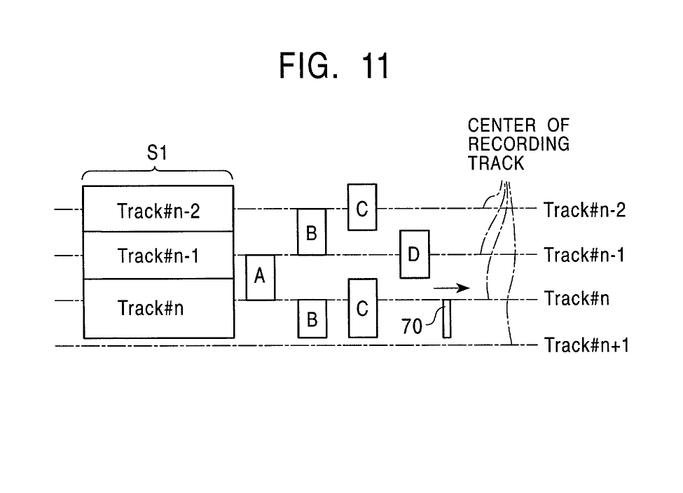

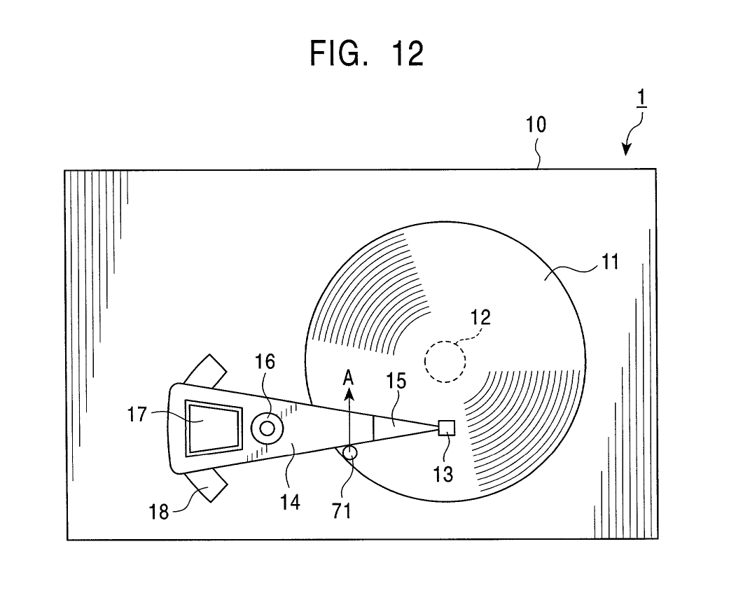

In step S58, the write head 70 is again shifted by one half the track pitch of the recording track such that an end (upper end in FIG. 11) of the write head 70 is at the center of the recording track (n), as shown in FIG. 11.

In step S59, the AGC/SYNC signal, the servo address mark signal, and the address signal in the servo signal are recorded by moving the write head 70 along the recording track (n) in a direction indicated by the arrow as shown in FIG. 11.

Thereafter in step S60, the B and C signals in the servo signal are recorded. Simultaneously, an end of the A signal which has been recorded in step S56 is erased. Thus, the A signal is recorded straddling across the recording tracks (n−1) and (n) with the same width as the track width.

In step S61, steps S59 and S60 are performed for the other servo segments located along the same concentric circle as that of the servo signal now being recorded.

Thus, the servo write operation is performed so that the servo signals are written for each and every recording track on the magnetic disc 11. As will be seen from the above description, since the ABCD burst signal is recorded straddling across a plurality of recording tracks, a two-step recording process involving the one-half track shifting of the write head 70 is required in order to record the servo signals for a single track.

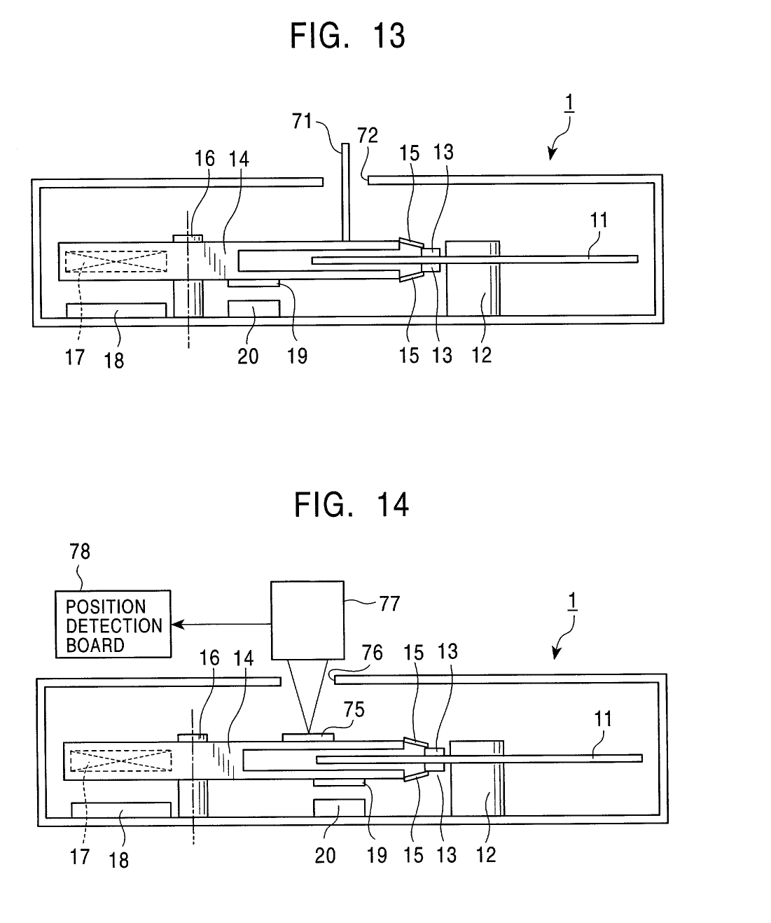

During the servo write operation, the servo signals must be recorded with great precision in order to ensure an accurate and stable recording/playback operation. Accordingly, the write head 70 must be shifted by one-half track with great accuracy. The accuracy with which the write head 70 is shifted must be higher than that with which the support arm 14 is transported. To ensure this, a push pin 71 is inserted from the outside of the magnetic disc apparatus 1 during the servo write operation, as shown in FIGS. 12 and 13. This ensures that as the support arm 14 is transported in a direction of the arrow A in FIG. 12, the magnetic heads 13 can be used as the write head 70 and shifted with high accuracy.

Specifically, the push pin 71 is a mechanical pin controllable with great positioning accuracy. The push pin 71 is inserted via a hole 72 provided in the magnetic disc apparatus 1. When the pin 71 is in place, the support arm 14 is urged with a slight force towards the opposite direction to the movement directed by the push pin 71. This allows the support arm 14 to closely contact the push pin 71 when the former is actuated by the voice coil motor 17, so that the magnetic heads 13 can be transported with great accuracy. When the servo write operation is over, the hole 71 is closed by an adhesive tape and the like so that the magnetic disc apparatus 1 is hermetically sealed.

The magnetic heads 13 may be transported by other means than the mechanical pin during the servo write operation. For example, Japanese Patent No. 2998051 discloses a method of transporting the magnetic head by means of a high-resolution contactless position detector.

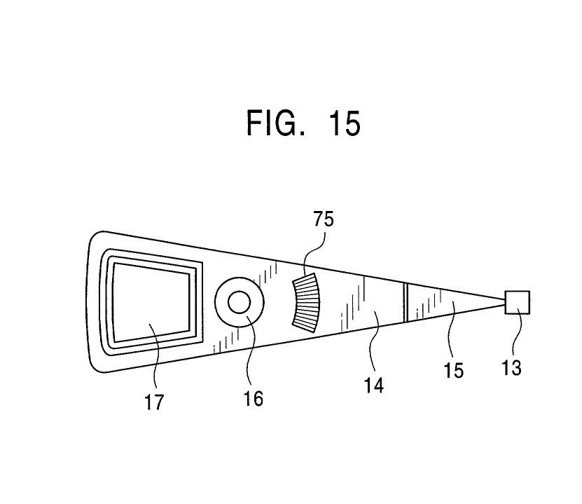

When this method is used for the servo write operation, a hologram grating 75 is provided on the support arm 14, as shown in FIGS. 14 and 15. Opposite the hologram grating 75 is disposed a laser scale optical unit 77 via an opening 76 provided in the magnetic disc apparatus 1. The laser scale optical unit 77 emits laser light which strikes the hologram grating 75 via the opening 76. Light refracted by the hologram grating 75 is detected by the laser scale optical unit 77. The detected result is analyzed by a position detection board 78 equipped in an external computer system and the like. The support arm 14 is then actuated and the magnetic heads 13 are used as the write head 70 and transported with high accuracy. The opening 76 is closed by an adhesive tape and the like after the servo write operation.

The above-mentioned patent states that the method allows the magnetic head to be more precisely transported than in the case of using the push pin 71 during the servo write operation. The hologram grating 75 and the laser scale optical unit 77 are equivalent to the hologram grating 19 and the hologram sensor unit 20, respectively, of the magnetic disc apparatus 1. However, the laser scale optical unit 77 differ from the hologram sensor unit 20 in that the former is disposed outside the magnetic disc apparatus 1 and used only for the servo write operation.

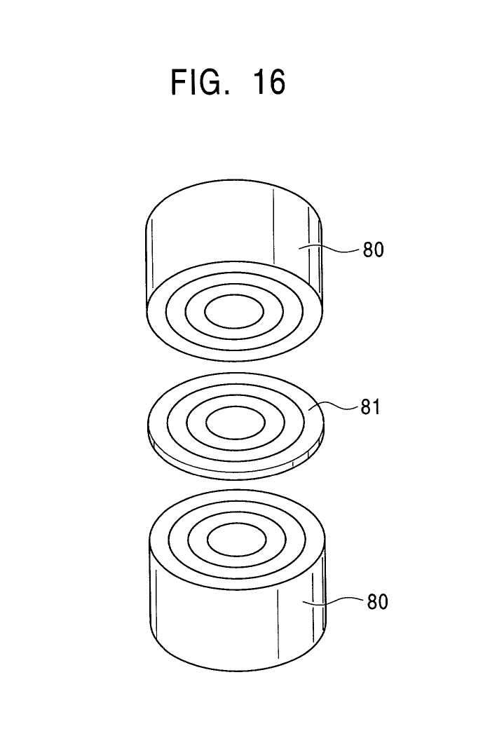

The magnetic disc 11 may be a PERM (pre-embossed rigid magnetic) disc where a concave/convex pattern corresponding to the servo signal is formed on a resin substrate by a stamping technique, rather than using the servo write operation as mentioned above. In this case, first a substrate 81 for the magnetic disc 11 is formed by injection-molding a resin material, using a stamper 80 on which the concave/convex pattern corresponding to the servo signal is formed, as shown in FIG. 16. The concave/convex pattern of the stamper 80 is transferred to each main surface on either side of the substrate 81. The transfer of the concave/convex pattern can be performed with high accuracy as long as the concave/convex pattern is formed on the stamper 80 with high accuracy.

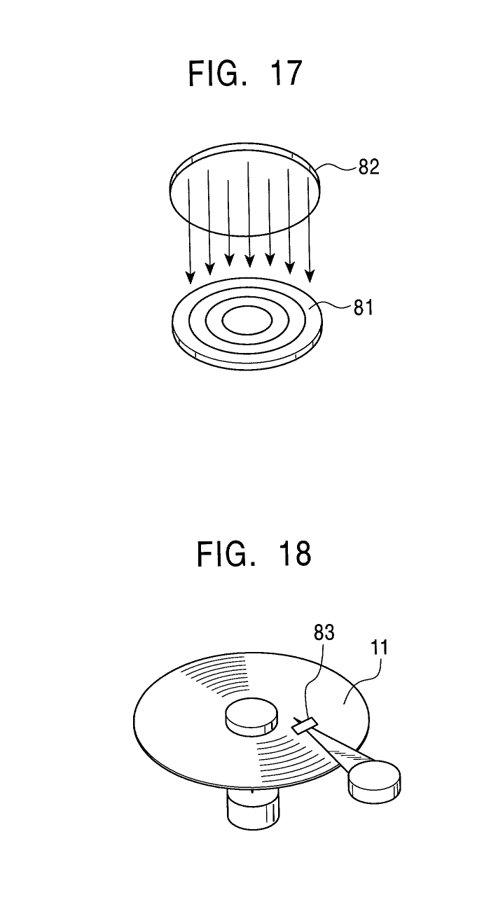

The substrate 81 is then subjected to spattering, for example, by means of a target material 82 formed from a magnetic material, as shown in FIG. 17. This causes a thin magnetic layer to be formed on each main surface of the substrate 81, thereby completing the magnetic disc 11 which has the concave/convex pattern corresponding to the servo signal formed on each of the signal recording surfaces. Thereafter, as shown in FIG. 18, the concave/convex pattern formed on each signal recording surface of the magnetic disc 11 is magnetized by means of a magnetic head 83, for example, so that the concave/convex pattern can function as the servo signal. The magnetization is preferably performed by recording a predetermined magnetic signal on only the convex portions of the concave/convex pattern, for that is easier and does not require a highly accurate positioning maneuver.

By producing the magnetic disc 11 and recording the servo signals thereon in the above-described manner, the servo signals can be highly accurately recorded on the magnetic disc 11, as long as the concave/convex pattern is formed on the stamper with high accuracy. This also makes it possible to manufacture a great quantity of the magnetic discs 11 at low cost. The stamping technology can also be used in the case where the servo signals are recorded on the magnetic disc spirally, as shown in FIG. 6B. In this case, too, the magnetic disc 11 in which the servo signals are highly accurately recorded can be easily mass-produced.

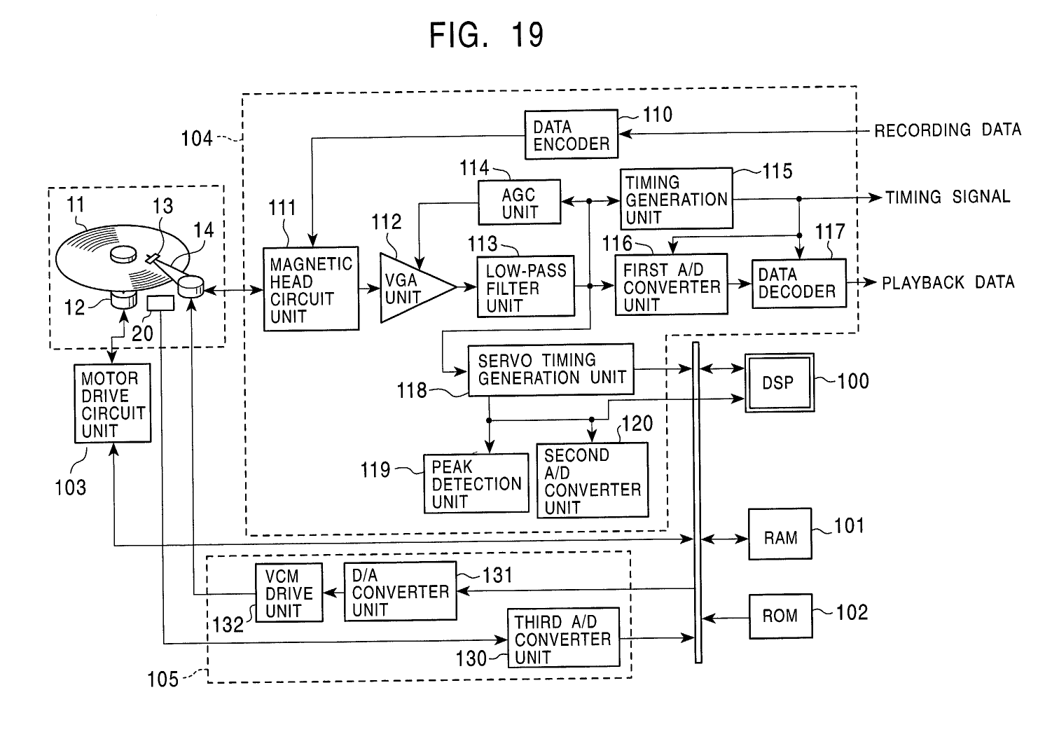

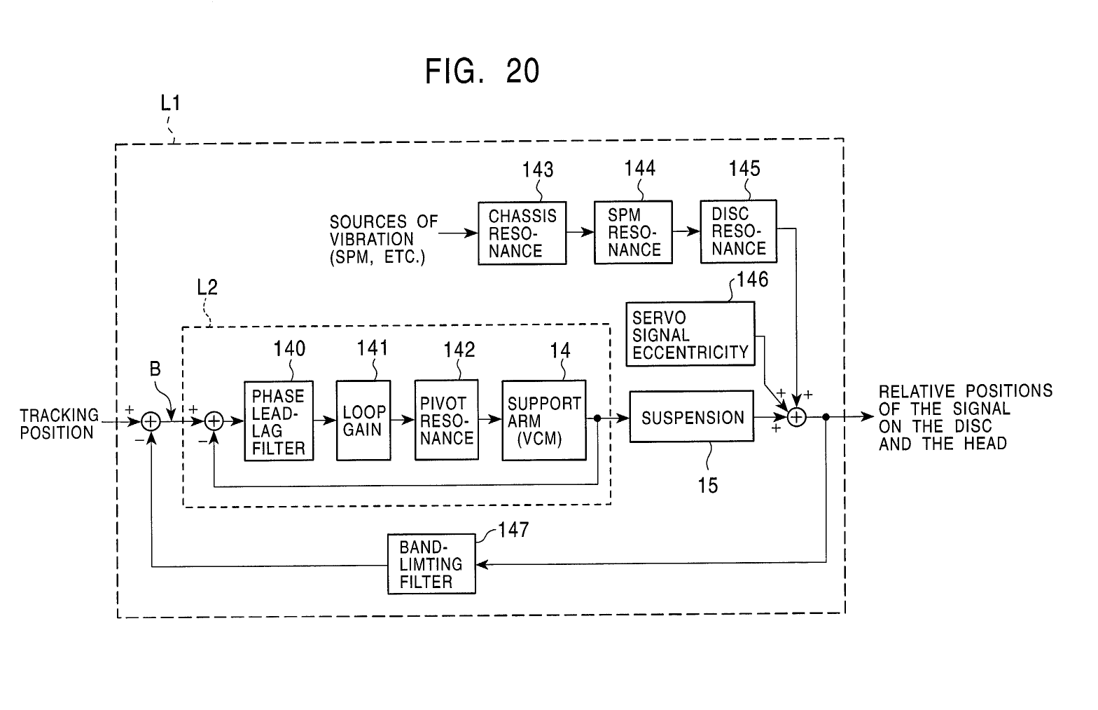

Hereafter, a control circuit equipped in the magnetic disc apparatus 1 will be described by referring to FIG. 19.

The control circuit controls the operation of various parts of the magnetic disc apparatus 1. It comprises a DSP (digital signal processor) 100, and a RAM (random access memory) 101 for temporarily storing information to be processed by the DSP 100. It also comprises a ROM (read-only memory) 102 for storing an application program defining an operating procedure to be performed by the DSP 100. The control circuit further comprises a motor drive circuit for driving the spindle motor 12, and a signal processing unit 104. The signal processing unit 104 processes the information signal to be recorded and/or played back on or from the magnetic disc 11. The control circuit further comprises a support arm actuating unit 105. The support arm actuating unit 105 controls the transportation of the support arm 14 by actuating the voice coil motor 17 of the support arm 14.

The DSP 100 controls the operation of various parts of the magnetic disc apparatus 1 by computing and processing various information in accordance with the operating procedure defined by the application program stored in the ROM 102.

The motor drive circuit unit 103, under the control of the DSP100, controls the rotation speed of the spindle motor 12 by varying the current supply to the spindle motor 12 of the magnetic disc apparatus 1. During the recording/playback, the spindle motor 12 is controlled by the motor drive control unit 103 such that the magnetic disc 11 can be rotated at a predetermined rotation speed. The magnetic disc 11 is rotated with a constant linear velocity (CLV) or a constant angular velocity (CAV), at a rotation speed of 2500 rpm or less, for example.

As shown in FIG. 19, the signal processing unit 104 comprises a data encoder 110, a magnetic head circuit unit 111, a VGA (variable gain amplifier) unit 112, a low-pass filter unit 113, an AGC (auto gain control) unit 114, a timing generation unit 115, a first A/D converter unit 116, a data decoder 117, a servo timing generation unit 118, a peak detection unit 119, and a second A/D converter unit 120. In the following, the individual parts of the signal processing unit 104 will be described in the order of signal (data) flow.

The signal processing unit 104 receives data to be recorded on the magnetic disc 11 (recording data) from any of a variety of information processing systems connected externally to the magnetic disc apparatus 1. The recording data is modulated or encoded or otherwise processed by the data encoder 110 in the signal processing unit 104. The recording data thus encoded by the data encoder 110 is then input to the magnetic head circuit unit 111.

The magnetic head circuit unit 111 comprises a driver circuit and an amplifier circuit. The driver circuit energizes the magnetic heads 13 by supplying an electric current thereto corresponding to the recording data. The amplifier circuit amplifies a playback signal detected by the magnetic heads 13.

During a recording operation, the magnetic head circuit unit 111 varies the current supply to the magnetic heads 13 on the basis of the recording data received from the data encoder 110. Thus, the magnetic heads 13 are energized to record an information signal corresponding to the recording data in the magnetic layer of the magnetic disc 11.

On the other hand, during a playback operation, the magnetic head circuit unit 111 amplifies the playback signal detected by the magnetic heads 13 as a current variation corresponding to the information signal recorded on the magnetic disc 11. Accordingly, even when the magnetic heads 13 uses the GMR element or TMR element as the magneto-sensitive element and, as a consequence, the playback signal output is weak, the playback signal is amplified, thereby ensuring a successful processing of the signal in subsequent stages.

The playback signal thus amplified by the magnetic head circuit unit 111 is input to the VGA unit 112. The VGA unit 112 adjusts the gain of the playback signal and then outputs it to the low-pass filter unit 113.

The low-pass filter unit 113 passes only a low-frequency component of the playback signal. The low-pass filtered signal is output to the AGC unit 114, the timing generation unit 115, the first A/D converter unit 116, and the servo timing generation unit 118.

The AGC unit 114 controls the VGA unit 112 based on the peak level of the input playback signal. As a result, the VGA unit 112 outputs a constant level of the playback signal at all times.

The timing generation unit 115 is formed by a PLL (phase-locked loop) circuit, for example. It detects a synchronization clock contained in the input playback signal and then generates a timing signal. The timing signal is output to the information processing system connected outside the magnetic disc apparatus 1, as well as to the first A/D converter unit 116 and the data decoder 117.

The first A/D converter unit 116 performs a digital conversion processing on the playback signal and generates digital data, which is output to the data decoder 117.

The data decoder 117 modulates, decodes, or otherwise processes the digital data it received, thereby generating playback data. The playback data is output to the external information processing system.

The servo timing generation unit 118 extracts the servo signal from the playback signal. The servo timing generation unit 118 also generates a servo timing signal based on the AGC/SYNC signal contained in the servo signal. The servo timing signal is necessary for decoding the information about track address contained in the servo signal. The servo signal and the servo timing signal are output to the peak detection unit 119, the second A/D converter unit 120, and the DSP 100.

The peak detection unit 119 detects the peak level of each of the A, B, C, and D signals based on the ABCD burst signal in the servo signal. The peak levels indicate a positioning error of the magnetic heads 13 from a particular recording track. The peak levels of the individual signals are output to the second A/D converter unit 120.

The second A/D converter unit 120 performs a digital conversion processing on the peak levels of the individual signals in the ABCD burst signals based on the servo timing signal received from the servo timing generation unit 118. The processed signals are output to the DSP 100.

The DSP 100 generates a track address indicating the track number and sector number and the like of the recording track being scanned by the magnetic heads 13, based on the servo signal and servo timing signal received from the servo timing generation unit 118. The DSP 100 also generates a tracking signal indicating the positioning error of the magnetic heads 13 from the recording track, based on the peak levels of the individual signals in the ABCD burst signal received from the second A/D converter unit 120.

Now referring to the support arm actuating unit 105, it comprises a third A/D converter unit 130, a D/A converter unit 131, and a VCM (voice coil motor) drive unit 132.

The third A/D converter unit 130 performs a digital conversion processing on the output signal output from the hologram sensor unit 20 in response to the movement of the support arm 14, and outputs the processed signal to the DSP 100.

The D/A converter unit 131 receives a signal from the DSP 100 indicating the tracking position of the magnetic heads 13, performs an analog conversion processing on it, and outputs the analog signal to the VCM drive unit 132.

The VCM drive unit 132 controls the current supply to the voice coil motor 17 of the support arm 14, based on the analog signal received from the D/A converter unit 131, thereby suitably transporting the support arm 14.

Hereafter, the operation of the magnetic disc apparatus 1 with the thus constructed control circuit during the recording/playback of the information signal will be described.

First, the motor drive circuit unit 103, under the control of the DSP 100, drives the spindle motor 12 so that the motor rotates at a predetermined speed. As a result, the magnetic disc 11 is rotated at a predetermined angular velocity, for example.

The playback signal is output from the magnetic heads 13. The servo signal recorded on the magnetic disc 11 is extracted from the playback signal by the servo timing generation unit 118, the peak detection unit 119, the second A/D converter unit 120, and the DSP 100.

Here, the servo timing generation unit 118 performs an AGC and a PLL control on the servo signal based on the AFC/SYNC signal contained in the servo signal, while generating a servo clock signal. Thus, the servo clock is “locked”. Based on the servo clock signal and the peak levels of the ABCD burst signal received via the peak detection unit 19 and the second A/D converter unit 120, the DSP 100 generates a position error signal (PES). The DSP 100 also extracts from the address signal the track address including the track number and sector number of the recording track being scanned by the magnetic heads 13, based on the servo clock signal.

Based on the extracted track address, the DSP 100 then determines the current position of the magnetic heads 13 on the magnetic disc 11. The DSP 100 compares the current position with the track address of the recording track where a recording/playback operation is to take place. The DSP 100 then generates a control signal for controlling the support arm 14 such that the magnetic heads 13 can be transported to the target recording track. The control signal is output to the support arm actuating unit 105, whereby the support arm 14 is moved and thus the magnetic heads 13 are transported to the desired recording track, where the recording/playback operation of the information signal takes place.

Thus, in the magnetic disc apparatus 1, the support arm 14 is actuated in accordance with the control signal, such that the magnetic heads 13 can be transported to a predetermined recording track for the recording/playback operation.

The control signal output by the DSP 100 is adjusted in accordance with the PES, which was generated on the basis of the ABCD burst signal contained in the servo signal recorded on the magnetic disc 11, so that the magnetic heads 13 can follow the recording track.

The DSP 100 also obtains through the support arm actuating unit 105 the information detected by the hologram sensor unit 20, indicating the position of the support arm 14. Using this information, the DSP 100 generates a position signal indicating the position of the support arm 14, i.e., the magnetic heads 13, with respect to the magnetic disc 11. Based on the position signal, the DSP 100 corrects the control signal for controlling the support arm 14.

Thus, the magnetic disc apparatus can perform the so-called tracking operation, whereby the magnetic heads 13 can accurately follow the target recording track.

The tracking operation in the magnetic disc apparatus 1 will be hereafter described in more detail by referring to the control block shown in FIG. 20.

During the tracking operation in the magnetic disc apparatus 1, the DSP 100 determines the position on the magnetic disc 11 where the magnetic heads 13 are to scan (tracking position), in accordance with the track address of the recording track on which a recording/playback operation is to take place. The DSP 100 then generates the control signal and controls the support arm 14, so that the magnetic heads 13 can be transported to the tracking position, where the recording/playback operation is performed.

During the tracking operation, the DSP 100 performs a digital processing on the control signal by means of a phase lead-lag filter 140 and a loop gain 141, as shown in FIG. 20. Thus, the digitally processed control signal is output to the support arm actuating unit 105, whereby the support arm 14 is actuated. The actuation of the support arm 14 is influenced by a mechanical vibration 142 occurring in the rotation axle 16 of the support arm 14 (pivot vibration). As the support arm 14 moves, the magnetic heads 13 mounted at the tip of the support arm 14 via the suspensions 15 are transported to the target position relative to the magnetic disc 11, thereby performing the tracking operation.

In the loop gain 141, the DSP 100 performs a digital processing on the control signal, such that the servo band, the phase margin, and the gain margin all satisfy necessary values for the tracking operation.

In the magnetic disc apparatus 1, the positioning of the magnetic heads 13 is influenced by various resonances including a chassis resonance 143 in the base 10, an SPM resonance 144 in the spindle motor 12 itself, and a disc resonance 145 in the magnetic disc 11, caused by such a source of vibration as the spindle motor 12 rotating the magnetic disc 11. Furthermore, the positioning of the magnetic heads 13 is also influenced by a servo signal eccentricity 146. This is the eccentricity with which the servo signals are recorded on the magnetic disc 11 with respect to the center of rotation of the magnetic disc 11.

Using the position error signal generated based on the playback signal output from the magnetic heads 13, the DSP 100 adjusts the control signal in a first servo loop L1, as shown in FIG. 20. The DSP 100 also corrects the control signal during the positioning of the magnetic heads 13 in a second servo loop L2, as shown in FIG. 20. The correction is based on the position signal detected by the hologram sensor unit 20 which indicates the position of the support arm 14.

Thus, in the magnetic disc apparatus 1, the positioning of the magnetic heads 13 is servo-controlled in two stages by the first and second servo loops L1 and L2. The first servo loop L1 uses the information about the relative positions of the magnetic disc 11 and the magnetic heads 13k based on the servo signals recorded on the magnetic disc 11. The second servo loop L2 uses the information about the position of the magnetic heads 13 which is externally detected by the hologram grating 19 and the hologram sensor unit 20.

The servo control of the magnetic heads 13 will be hereafter described in more detail.

In a typical magnetic disc apparatus, if the track pitch of the recording tracks is narrowed to increase the recording density of the magnetic disc, the magnetic head has to be positioned with a correspondingly high accuracy. Specifically, the accuracy with which the magnetic head is positioned has to be on the order of 10% to 15% of the track pitch. This means that a positioning accuracy of the order of ±50 nm to ±75 nm (i.e., 100 nm to 150 nm) is required when the track pitch is about 1 μm. Likewise, a positioning accuracy of the order of ±25 nm to ±35 nm (i.e., 50 nm to 70 nm) is required when the track pitch is about 0.5 μm.

In order to position the magnetic head with such a high accuracy, it is important to reduce the various mechanical resonances in the magnetic disc apparatus, the fluctuation of the rotation axle of the spindle motor, the eccentricity of the magnetic disc, or such tracking errors as RRO (repetitive run-out) and NRRO (non-repetitive run-out). In the prior art, methods have been proposed whereby the RRO is reduced by a learning control feed-forward control during the positioning of the magnetic head. However, it is necessary to reduce not only the RRO but NRRO sufficiently if the tracking of the magnetic head is to be performed with high accuracy.

In order to reduce the tracking error in the magnetic disc apparatus, the NRRO can be reduced by increasing the mechanical precision of the apparatus, or the servo band by which the positioning of the magnetic head is controlled can be raised.

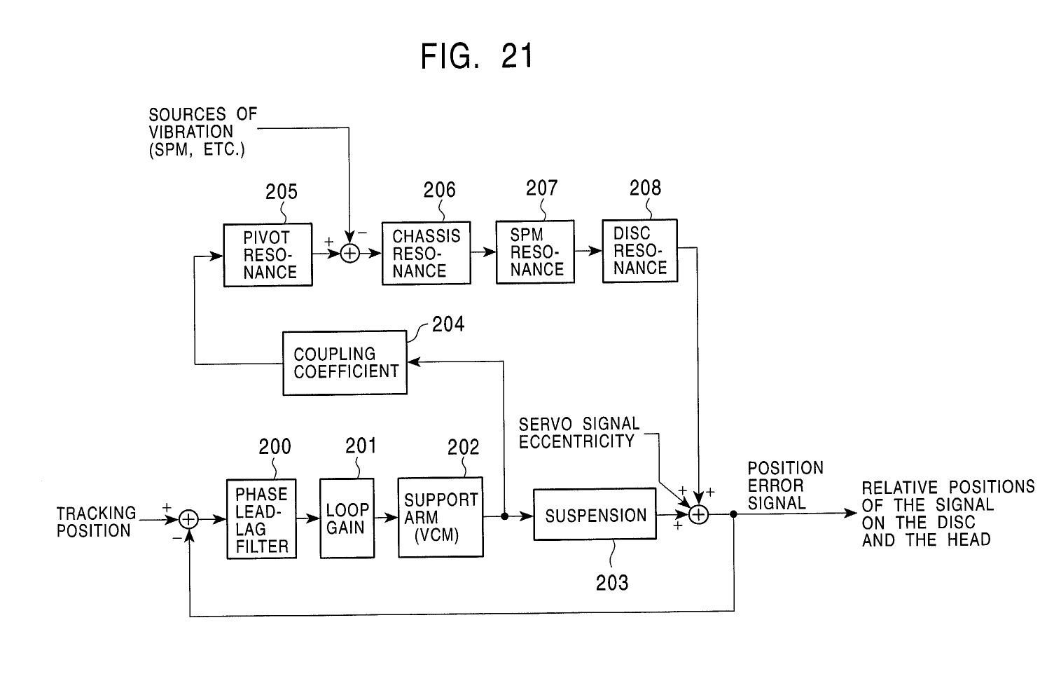

However, when the servo band is raised, it is necessary that there is no large resonance in a frequency band which lies within 6 to 10 times the zero-crossing frequency of the servo. In the conventional magnetic disc apparatus, there are various mechanical resonances in the servo loop, as shown in FIG. 21. Due to these mechanical resonances, many large resonances arise in a frequency band of not more than 10 times the zero-crossing frequency of the servo. Thus, it has been extremely difficult to raise the servo band.

In the magnetic disc apparatus 1 in accordance with the present invention, however, the two-stage servo control is effected involving the first and second servo loops L1 and L2, as shown in FIG. 20. As mentioned above, the first servo loop L1 uses the position error signal which varies depending on the relative positions of the magnetic heads 13 and the magnetic disc 11. The second servo loop L2 uses the position signal indicating the position of the support arm 14 (i.e., the magnetic heads 13).

Of these two servo loops, the second servo loop L2 is influenced only by the pivot resonance 142 occurring in the rotation axle 16 of the support arm 14 and the mechanical resonance of the support arm 14 itself. Accordingly, the second servo loop L2 has excluded the influences of the chassis resonance 143, the SPM resonance 144, the disc resonance 145, the servo signal resonance 146, and the suspension 15, by which the conventional magnetic disc apparatus was influenced. Thus, the servo band can be raised in the second servo loop L2 so as to position the magnetic heads 13 with high accuracy.

The fact that the magnetic disc apparatus 1 comprises the second servo loop L2 in the in addition to the first servo loop L1, which is based on the position error signal generated from the servo signal recorded on the magnetic disc 11, also makes it possible to greatly increase the servo sampling frequency.

In the conventional magnetic disc apparatus, the servo sampling frequency was dependent on the rotation speed of the magnetic disc and the number of patterns per track of the servo signal formed on the magnetic disc. This is because the servo control of the positioning of the magnetic head is based only on the servo signal recorded on the magnetic disc. For example, when the rotation speed of the magnetic disc is 5400 rpm, and the number of patterns of the servo signal per track on the magnetic disc is ranging from 60 to 90, the servo sampling frequency for the servo control of the magnetic head 13 becomes about 8 kHz.

Thus, it is necessary in the conventional magnetic disc apparatus to increase the rotation speed of the magnetic disc or the number of patterns of the servo signal formed per track in order to increase the servo sampling frequency. However, there is a limit to how much either the rotation speed or the pattern number can be increased. It has been thus difficult to increase the sampling frequency, which is considered one of the factors limiting the servo band.

In the magnetic disc apparatus 1 in accordance with the present invention, the sampling frequency in the second servo loop L2 is not dependent on the rotation speed of the magnetic disc 11 or the number of patterns of the servo signal; it is dependent only on the computing speed of the DSP 100. Accordingly, the sampling frequency in the second servo loop L2 can be set at 100 kHz, for example, which is more than ten times faster than in the conventional example. Thus, in the magnetic disc apparatus 1, the sampling frequency in the second servo loop can be significantly increased, so that the influences of the sampling time delay and the like can be reduced and the servo band can be set higher.

As shown in FIG. 20, the magnetic disc apparatus 1 preferably comprises a band-limiting filter 147 disposed in the first servo loop L1 based on the position error signal, so that only a predetermined frequency band of the position error signal is passed. In this manner, many large resonances that may exist in the position error signal due to the chassis resonance 143, the SPM resonance 144, the disc resonance 145, the servo signal eccentricity 146, and the suspension 15 can be removed. Thus, by providing the band-limiting filter 147 in the first servo loop L1, the accuracy with which the magnetic heads are positioned can be further increased.

In the conventional magnetic disc apparatus, there was a problem that the position error signal generated from the servo signal recorded on the magnetic disc cannot be limited with arbitrary bands because doing so deteriorates the servo gain margin or phase margin of the servo loop.

However, in the magnetic disc apparatus 1, the servo characteristics of the second servo loop L2 are not influenced by the provision of the band-limiting filter 147 in the first servo lop L1. Thus, the band-limiting filter 147 is able to band-limit the position error signal by using arbitrary filter characteristics. Accordingly, the band-limiting filter 147 may comprise a high-order low-pass filter with such a cut-off frequency located near the servo cut-off frequency as is inconceivable in the conventional magnetic disc apparatus.

The location of the band-limiting filter 172 is not limited as shown in FIG. 20, where the filter is inserted such that the filtering is performed on the position error signal prior to computation of the signal designating the tracking position. For example, the band-limiting filter 172 may be inserted prior to the second servo loop L2 (as indicated by an arrow B in FIG. 20) after computing the position error signal with the tracking-position designating signal. In this case, too, the filtering by the band-limiting filter 172 does not influence the second servo loop L2.

In the magnetic disc apparatus 1, a stable control system can be constructed even without the band-limiting filter 172, because the second servo loop L2 functions as a low-pass filter.

In the following, the features of the magnetic disc apparatus 1 in accordance with the present invention will be described.

Generally, the servo band in the magnetic disc apparatus is limited by the resonance of the floating slider, for example, traveling above the signal recording surface of the magnetic disc, together with the mounted magnetic head. As a result, the servo band in the conventional magnetic disc apparatus is from several hundred hertz to one kilohertz.

Also, the magnetic disc generally has a resonance caused by its rotation. In the conventional magnetic disc apparatus, the influence of the resonance of the magnetic disc has not been considered much because the track pitch was usually set at 1 μm or more. However, as the track pitch has become increasingly smaller to achieve a higher recording density, so has the influence of the resonance of the magnetic disc become more and more pronounced, making it all the more difficult to stably perform the normal recording/playback operation.

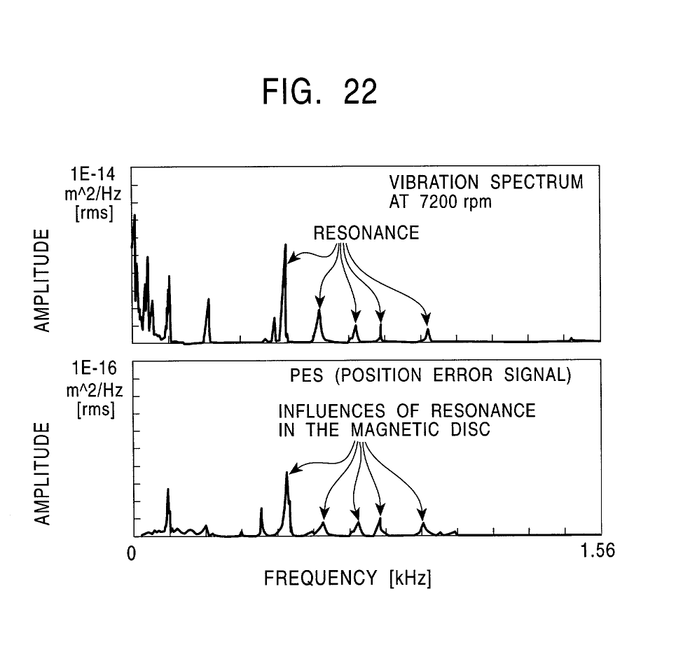

Specifically, when the magnetic disc with a diameter of 8.75 cm (3.5 inches) is rotated at 7200 rpm, the magnetic disc resonates as shown in FIG. 22. As a result, the position error signal (PES) obtained from the servo signal recorded on the magnetic disc fluctuates in the direction of the recording tracks. Such fluctuation of the PES has posed a difficulty in realizing a track pitch of the order of 0.5 μm in the conventional magnetic disc apparatus.

The vibration caused in the rotating magnetic disc can be expressed by the following equation:

$$W = \frac{F ( r p m ) {a}^{2} ( 1 - {v}^{2} )}{E β {h}^{3} {λ}^{4}} \qquad ( Equation 1 )$$

wherein W is the amplitude of the vibration occurring in the magnetic disc, F(rpm) is a pressure of turbulence of the air (a function of the rotation speed rpm) within the magnetic disc apparatus, a is an external radius of the magnetic disc, E is the Young's modulus of the substrate material of the magnetic disc, β is the damping factor of the magnetic disc, h is the thickness of the magnetic disc, λ² is a shape parameter of the magnetic disc, and γ is a Poisson ratio of the substrate material of the magnetic disc.

In the conventional magnetic disc apparatus, a glass material with a high rigidity is used as the substrate material for the magnetic disc, in order to increase the value of Young's modulus E in Equation 1 and thereby reduce the amplitude W of vibration of the magnetic disc. Also, in the conventional magnetic disc apparatus, a small-diameter magnetic disc is used to reduce the value a in Equation 1, so that the vibration amplitude W can be reduced.

In the magnetic disc apparatus 1 in accordance with the present invention, however, the influence of the vibration of the magnetic disc 11 is reduced by using different approaches from the methods as mentioned above, as described below.

First, the magnetic disc 11 is rotated at not more than 2500 rpm by the spindle motor 12 to reduce the influence by the term F (rpm) in Equation 1, thereby suppressing the amplitude W of vibration in the magnetic disc 11. By thus reducing the rotation speed below 2500 rpm, furthermore, higher-order vibration modes which are proportional to the rotation speed of the magnetic disc 11 can be shifted to lower frequency regions.

Secondly, the diameter of the magnetic disc is made 10 cm or more, so that the fundamental frequency of vibration in the magnetic disc 11 can be shifted to a lower frequency region. This makes it possible to reduce the vibration near the zero-crossing frequency of the gain characteristics while shifting the vibration frequency of the magnetic disc 11 to within the servo band. Accordingly, the influence of the vibration of the magnetic disc 11 can be absorbed by the servo system, and therefore the magnetic heads 13 can be made to follow a desired track in a stable and reliable manner.

In the magnetic disc apparatus 1, the substrate material for the magnetic disc 11 may be a glass, metal, or resin material. From the viewpoint of suppressing the vibration, however, a resin material is particularly preferable. A typical resin material has a Young's modulus which is 1/35 that of a typical glass material widely used as the material for the magnetic disc substrate in the conventional magnetic disc apparatus. Accordingly, by constructing the magnetic disc 11 with a resin material, the vibration occurring in the magnetic disc 11 can be shifted to a lower frequency region.

Further, by constructing the magnetic disc 11 with a resin substrate, the damping effect can be improved, so that vibrations occurring in a high frequency region of the order of 600 Hz to 1 kHz can be significantly reduced.

Thus, the magnetic disc apparatus 1 is designed to use the magnetic disc 11 with a diameter of 10 cm or more and perform a recording/playback operation while rotating the magnetic disc at a relatively slow speed of 2500 rpm or less. Accordingly, the vibration in the magnetic disc 11 can be reduced and a smaller track pitch can be employed.

By employing a resin material in the substrate of the magnetic disc 11, the vibration components of the magnetic disc 11 during rotation can be further shifted to a lower frequency region. As a result, the vibration-absorbing function of the servo system can be enhanced and a stable and reliable tracking operation of the magnetic heads 13 can be performed.

When the magnetic disc 11 is constructed by a resin-material substrate, its thickness should preferably be not less than 1 mm and not more than 2.5 mm. If the thickness is less than 1 mm, the vibration caused by the rotation of the magnetic disc 11 becomes significant, making it difficult to perform a stable recording/playback operation. If the thickness is more than 2.5 mm, on the other hand, it becomes difficult to form the magnetic disc 11 with high precision.

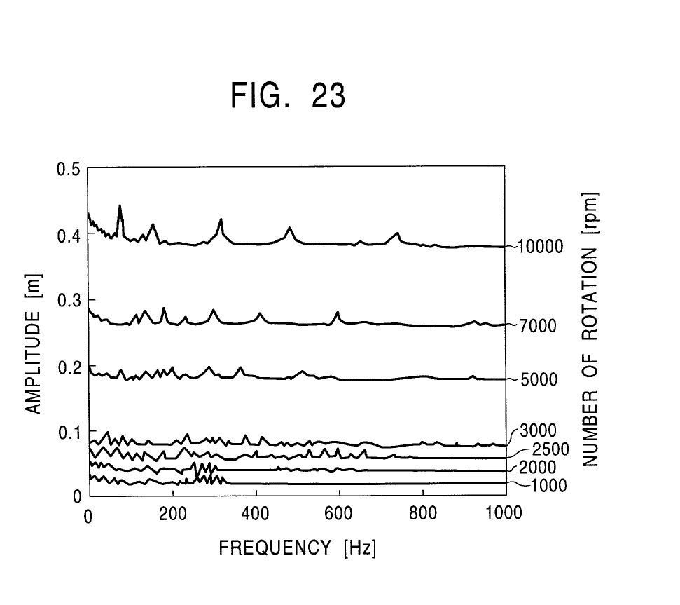

FIG. 23 shows the relationship between the amplitude and frequency of the vibration caused in the magnetic disc and the rotation speed of the magnetic disc when the magnetic disc is formed by a substrate using a resin material. As will be seen from the figure, the amplitude of vibration can be suppressed more and more with a decreasing rotation speed of the magnetic disc. As will also be seen from the figure, the vibration components of a frequency region above 300 Hz can be suppressed by making the rotation speed of the magnetic disc less than 2500 rpm.

Thus, in the magnetic disc apparatus 1, the frequency components of the vibration occurring in the magnetic disc 11 can be lowered below about 300 Hz. Furthermore, by providing the magnetic disc apparatus 1 with a servo system with a 1-kHz servo band, an open loop gain of 12 dB or more can be obtained in the servo system at 300 Hz. Accordingly, due to such suppressing effects by the servo system, the amplitude of vibration in a frequency region of around 300 Hz among vibrations occurring in the magnetic disc 11 can be further reduced by a factor of four or more.

Since the magnetic disc apparatus 1 rotates the magnetic disc 11 at a rotation speed of 2500 rpm or less, the life of the spindle motor 12 can be extended, while reducing the noise generated by the rotation of the magnetic disc 11 and the spindle motor 12.

Thus, in the magnetic disc apparatus 1, the vibration of the magnetic disc 11 can be suppressed and a stable and reliable recording/playback operation can be performed.

When the magnetic disc apparatus 1 is used as part of hard disc recording equipment or home server equipment, the storage capacity and the transfer rate must be considered carefully. In the following, therefore, the advantage of the magnetic disc apparatus 1 will be described in terms of these factors.

When the magnetic disc apparatus 1 is used in hard disc recording equipment or home server equipment, for example, a storage capacity of 50 GB or more is required. This storage capacity is necessary for storing at least half an hour worth of moving image data compressed by a long-time mode MPEG2 coding system.

In order to achieve the storage capacity of 50 GB in the conventional magnetic disc apparatus, two magnetic discs with a diameter of 8.75 cm (3.5 inches) each are required.

In the magnetic disc apparatus 1, however, since the diameter of the magnetic disc 11 is 10 cm or more, the 50-GB storage capacity can be achieved by a single magnetic disc 11. Thus, in the magnetic disc apparatus 1, the numbers of magnetic discs and magnetic heads to be mounted can be reduced as compared with the prior art, thereby helping to reduce costs.

When the magnetic disc apparatus 1 is mounted in hard disc recording equipment or home server equipment, for example, a high transfer rate is required. Specifically, a sufficient transfer rate must be ensured in order to record and/or playback at least three streams of HDTV (high-definition television broadcast). Since one stream of HDTV requires a transfer rate of 28 Mbps, a transfer rate of three times that rate, i.e., 84 Mbps or so must be provided in the magnetic disc apparatus 1.

In the magnetic disc apparatus 1, the linear recording density during the recording/playback on the magnetic disc 11 is 500 kbpi. Accordingly, when the internal diameter of the magnetic disc 11 is 3.75 cm (1.5 inches) and the rotation speed of the magnetic disc 11 is 2400 rpm, a transfer rate of about 95 Mbps can be ensured during a recording/playback operation even for an inner-most recording track of the magnetic disc 11. Thus, a sufficient transfer rate is ensured in the magnetic disc apparatus 1 for applications in hard disc recording equipment or home server equipment, for example.

As described above, the position of the support arm 14 (i.e., the position of the magnetic heads 13) is detected by the hologram grating 19 and the hologram sensor unit 20 in the magnetic disc apparatus 1. The signal output from the hologram sensor unit 20 is then input to the DSP 100 via the support arm actuating unit 105, and the DSP 100 generates the position signal. Thus, in the magnetic disc apparatus 1, a position detection means is constructed by the hologram grating 19, the hologram sensor unit 20, the support arm actuating unit 105, and the DSP 100, for detecting the position of the magnetic heads 13 and supplying the position signal.

Further, as described above, the position error signal (PES) contained in the playback signal detected by the magnetic heads 13 is extracted or detected by the signal processing unit 104 and the DSP 100. Based on the position error signal, the DSP 100 generates the control signal for controlling the actuation of the support arm 14. The control signal is corrected in the DSP 100 based on the position signal output by the support arm actuating unit 105. The control signal is output to the support arm actuating unit 105, whereby the support arm 14 is actuated by the support arm actuating unit 105. Thus, in the magnetic disc apparatus 1, the signal processing unit 104 and DSP 100 generates the control signal, based on the position error signal which is detected by the magnetic heads 13, for controlling the actuation of the support arm 14. The control signal is then corrected by the signal processing unit 104 and DSP 100 on the basis of the position signal output by the position detection means. And the actuation of the support arm 14 is controlled by the thus corrected control signal. Thus, the signal processing unit 104 and the DSP 100 constitute the control means for controlling the actuation of the support arm 14.

In the above description, the position of the support arm 14 (i.e., the magnetic heads 13) was detected by the optical scale consisting of the hologram grating 19 and the hologram sensor unit 20. However, this is merely exemplary and should not be taken as limiting the scope of the present invention. Yet, since the hologram grating 19 can be formed through a semiconductor process, the position of the support arm 14 can be easily detected by such optical scale with high resolution, which in turn makes it possible to highly accurately control the magnetic heads 13.

As the recording density of the magnetic disc 11 increases, it becomes increasingly necessary to control the support arm 14 ever more finely. When controlling the support arm 14 with such fineness, the influences of static friction and Coulomb friction arising in the rotation axle 16 of the support arm 14, for example, become significant, thereby making the system mode nonlinear.

In such a case, it is useful to perform a nonlinear control such as a pulse drive by applying a large pulse current to the voice coil motor 17 in opposition to the static friction or the Coulomb friction. In order to perform such a pulse control effectively, a high sampling frequency and a high positional resolution are necessary.

In the magnetic disc apparatus 1, the sampling frequency in the second servo loop L2 can be freely set at a high value, as mentioned above. Further, a high resolution is easily obtained in the magnetic disc apparatus 1 by the use of the optical scale for detecting the position of the support arm 14. Accordingly, the magnetic disc apparatus 1 is particularly suitable when controlling the support arm 14 with such a fine scale that the system mode becomes nonlinear.

The positional resolution of the optical scale consisting of the hologram grating 19 and the hologram sensor unit 20 should preferably be 1/40 or less of the track pitch of the recording tracks formed on the magnetic disc 11. The magnetic heads 13 must be positioned with an accuracy of 10% with respect to the recording track. Servo-controlling the magnetic heads 13 with such an accuracy requires that the position of the support arm 14 (i.e., the magnetic heads 13) be detected by the hologram sensor unit 20 with a resolution of at least twice the positioning accuracy ±5%. Accordingly, by determining the position of the support arm 14 with a resolution of 1/40 or less with respect to the recording track pitch, the magnetic heads 13 can be positioned with respect to the recording track with a sufficiently high accuracy.

In the above description, the support arm 14 is rotated about the rotation axle 16 in accordance with the current supplied to the voice coil motor 17, such that the magnetic heads 13 can be transported along the radius of the magnetic disc 11. However, the use of the support arm 14 is merely exemplary, and any support mechanism may be employed if it is capable of supporting and transporting the magnetic heads 13 along the radius of the magnetic disc 11. For example, the support mechanism may be realized by mounting the magnetic heads 13 on a tip of an arm linearly actuated by a linear motor and transporting the arm along the radius of the magnetic disc 11.

Thus, in the magnetic disc apparatus in accordance with the present invention, the control signal is generated on the basis of the position error signal recorded on the magnetic disc. The control signal is corrected in view of the position signal output from the position detection means, and the positioning of the magnetic head is controlled by the thus corrected control signal. The position signal output from the position detection means indicates the position of the magnetic head as detected externally, in contrast to the position error signal recorded on the magnetic disc. The position signal is therefore not dependent on the rotation of the magnetic disc. Thus, the resonance frequencies of the mechanical resonances due to the rotation of the magnetic disc can be reduced, and at the same time, the servo sampling frequency can be significantly increased. As a result, the influences of sampling time delay and the like can be reduced, so that the servo band can be set higher. Thus, in the magnetic disc apparatus according to the present invention, the magnetic head can be highly accurately positioned with respect to the magnetic disc, thereby allowing a recording/playback operation to be performed stably even at a high recording density.

What is claimed is:

1. A magnetic disc apparatus comprising:
a magnetic disc on which an information signal and a position error signal are recorded;
a spindle motor for rotating said magnetic disc;
a magnetic head for recording and/or playing back said information signal on said magnetic disc;
a support mechanism for supporting said magnetic head such that said magnetic head can be transported along the radius of said magnetic disc;
position detection means for detecting the position of said magnetic head to output a position signal; and
control means for generating a control signal on the basis of said position error signal detected by said magnetic head, correcting said control signal on the basis of said position signal received from said position detection means, and controlling the actuation of said support mechanism based on the corrected control signal, such that said magnetic head can be transported to a predetermined position.

2. A magnetic disc apparatus according to claim 1, wherein said position error signal is recorded by recording a magnetic signal on a fine concave/convex pattern formed on a signal recording surface of said magnetic disc where said information signal is recorded.

3. A magnetic disc apparatus according to claim 1, wherein said position detection means has a resolution of 1/40 or smaller with respect to a track pitch of a recording track formed on said magnetic disc.

4. A magnetic disc apparatus according to claim 1, wherein said position detection means comprises an optical scale which is adapted to detect the position of said magnetic head by illuminating a hologram with light.

5. A magnetic disc apparatus according to claim 1, further comprising filter means for band-limiting said position error signal detected by said magnetic head, so that only a predetermined frequency component is passed and output to said control means.

6. A magnetic disc apparatus according to claim 1, wherein said magnetic disc has a diameter of 10 cm or more and is rotated by said spindle motor at a rotation speed of 2500 rpm or less.

7. A magnetic disc apparatus according to claim 6, wherein said magnetic disc is recorded and/or played back at a linear recording density of 500 kbpi or more.

8. A magnetic disc apparatus according to claim 8, wherein said magnetic disc comprises a substrate which is formed from a resin material, and the thickness of said magnetic disc is in the range from 1 mm to 2.5 mm.

9. A magnetic disc apparatus according to claim 1, wherein said control means controls said support mechanism such that, when recording and/or playing back said information signal, said magnetic head travels on the signal recording surface of said magnetic disc in a spiral manner, whereby said information signal is recorded and/or played back in units of information extending as long as a single track of said magnetic disc or longer.

10. A magnetic disc apparatus according to claim 1, wherein said magnetic disc is formed by stamping a resin material, wherein said position error signal is provided at positions along each of a plurality of concentric circles of fine concave/convex patterns formed on the signal recording surface by the stamping, and wherein said control means controls and continuously actuates said support mechanism on the basis of said position error signal, such that said magnetic head travels on the signal recording surface of said magnetic disc in a spiral manner.

11. A magnetic disc apparatus according to claim 1, wherein said magnetic disc is formed by stamping a resin material, wherein said position error signal is provided at positions along a fine concave/convex pattern formed on the signal recording surface by the stamping, and wherein said control means controls and continuously actuates said support mechanism on the basis of said position error signal, such that said magnetic head travels on the signal recording surface of said magnetic disc in a spiral manner.
